(19) United States
(12) Patent Application Publication
(10) Pub. No.: US 2022/0164721 A1
(43) Pub. Date: May 26, 2022

(54) CHARGING CONTROL SYSTEM, CHARGING CONTROL APPARATUS, AND COMPUTER READABLE RECORDING MEDIUM

(71) Applicant: TOYOTA JIDOSHA KABUSHIKI KAISHA, Toyota-shi (JP)

(72) Inventors: Daiki Yokoyama, Gotemba-shi (JP); Daiki Kawachino, Sunto-gun (JP); Shota Tsukamoto, Susono-shi (JP); Rie Yayabe, Sunono-shi (JP); Masaaki Sato, Susono-shi (JP)

(73) Assignee: TOYOTA JIDOSHA KABUSHIKI KAISHA, Toyota-shi (JP)

(21) Appl. No.: 17/452,434

(22) Filed: Oct. 27, 2021

(30) Foreign Application Priority Data
Nov. 25, 2020 (JP) 2020-195273

(51) Int. Cl. G06Q 10/04; G06Q 50/06

(52) U.S. Cl. CPC G06Q 10/04; G06Q 50/06

(57) ABSTRACT

A charging control system includes: a charging apparatus including a first processor, the charging apparatus being configured to store electric power to be supplied to a preset area; an equipment group provided in the preset area and including a second processor, the equipment group being configured to be supplied with the electric power from the charging apparatus; and a charging control apparatus including a third processor, the third processor being configured to: predict an amount of atmospheric suspended particulate matter floating in the preset area; calculate, based on the predicted amount of the atmospheric suspended particulate matter, a removal electric power amount to be used to remove the atmospheric suspended particulate matter entering the equipment group; calculate a total electric power amount by adding the removal electric power amount to an electric power amount to be regularly supplied to the preset area; and perform charging control of storing electric power equal to or more than the total electric power amount in the charging apparatus.

The present application claims priority to and incorporates by reference the entire contents of Japanese Patent Application No. 2020-195273 filed in Japan on Nov. 25, 2020.

### BACKGROUND

The present disclosure relates to a charging control system, a charging control apparatus, and a computer readable recording medium.

There is a known technique for supplying electric power stored in a charging apparatus in advance to an equipment group provided in a smart city.

### SUMMARY

If there is a large amount of atmospheric suspended particulate matter (yellow sand, PM 2.5, and the like) in the atmosphere, the atmospheric suspended particulate matter enters an equipment group (a sensor, a camera, a charging stand, and the like) provided in a smart city, and the equipment group may malfunction. For this reason, if there is a large amount of atmospheric suspended particulate matter in the atmosphere, it is necessary to use the electric power stored in a charging apparatus to remove the atmospheric suspended particulate matter entering the equipment group, and which increases the electric power consumption more than usual.

There is a need for a charging control system, a charging control apparatus, and a computer readable recording medium that are able to prevent electric power from running short when atmospheric suspended particulate matter falls on a smart city.

According to one aspect of the present disclosure, there is provided a charging control system including: a charging apparatus including a first processor, the charging apparatus being configured to store electric power to be supplied to a preset area; an equipment group provided in the preset area and including a second processor, the equipment group being configured to be supplied with the electric power from the charging apparatus; and a charging control apparatus including a third processor, the third processor being configured to: predict an amount of atmospheric suspended particulate matter floating in the preset area; calculate, based on the predicted amount of the atmospheric suspended particulate matter, a removal electric power amount to be used to remove the atmospheric suspended particulate matter entering the equipment group; calculate a total electric power amount by adding the removal electric power amount to an electric power amount to be regularly supplied to the preset area; and perform charging control of storing electric power equal to or more than the total electric power amount in the charging apparatus.

### BRIEF DESCRIPTION OF THE DRAWINGS

FIG. 1 is a block diagram illustrating a charging control system according to an embodiment; and

FIG. 2 is a flowchart illustrating an example of a charging control method performed by the charging control system according to the embodiment.

### DETAILED DESCRIPTION

A charging control system, a charging control apparatus, and a computer readable recording medium storing a charging control program according to an embodiment of the present disclosure will be described with reference to the drawings. Note that, the constituent elements in the following embodiment include those that may be easily replaced by those skilled in the art or are substantially the same.

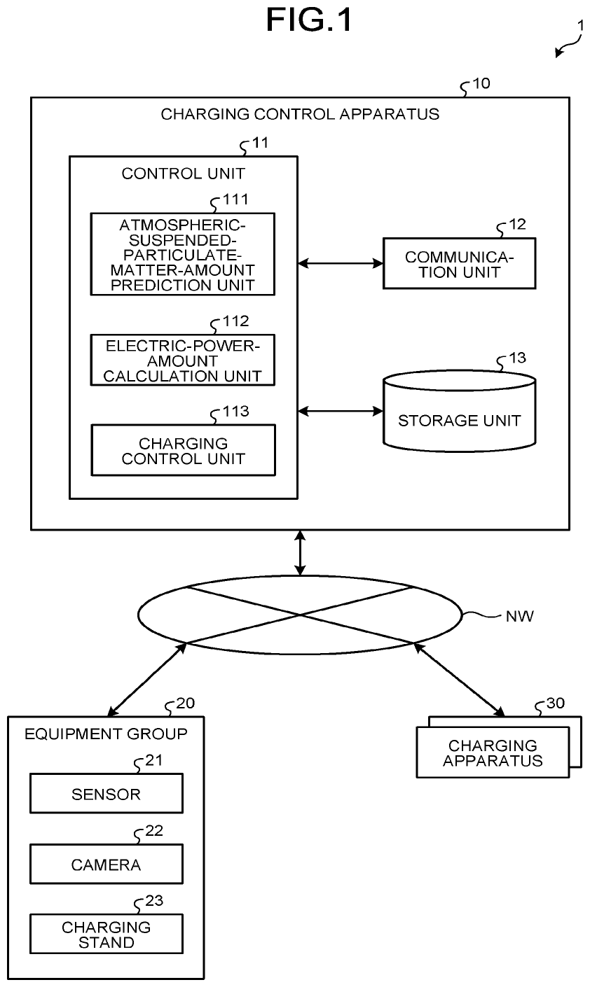

A charging control system including a charging control apparatus according to the embodiment will be described with reference to FIG. 1. The charging control system performs charging control of a charging apparatus that supplies electric power to a preset area. The “preset area” is an area where a large number of users live or that a large number of users use and is, for example, a smart city, a theme park, an amusement park, or the like. The present embodiment is described on the assumption that the area is a smart city.

As illustrated in FIG. 1, a charging control system 1 includes a charging control apparatus 10, an equipment group 20, and a plurality of charging apparatuses 30. The charging control apparatus 10, the equipment group 20, and the charging apparatuses 30 each have a communication function and are configured to be communicable with each other via a network NW. This network NW is implemented by, for example, an Internet network, a mobile phone network, or the like.

The charging control apparatus 10 is provided inside the smart city or outside the smart city. The charging control apparatus 10 is implemented by a general-purpose computer, such as a workstation or a personal computer.

As illustrated in FIG. 1, the charging control apparatus 10 includes a control unit 11, a communication unit 12, and a storage unit 13. The control unit 11 specifically includes a processor implemented by a central processing unit (CPU), a digital signal processor (DSP), a field-programmable gate array (FPGA) or the like, and a memory (main storage unit) implemented by a random access memory (RAM), a read only memory (ROM), or the like.

The control unit 11 loads and executes a program stored in the storage unit 13 in the work area of the main storage unit and controls each component or the like through the execution of the program to implement a function matching a predetermined purpose. The control unit 11 functions as an atmospheric-suspended-particulate-matter-amount prediction unit 111, an electric-power-amount calculation unit 112, and a charging control unit 113 through the execution of the program stored in the storage unit 13.

The atmospheric-suspended-particulate-matter-amount prediction unit 111 predicts an amount of atmospheric suspended particulate matter falling on a preset area (hereinafter, referred to as a “smart city”). A specific prediction method of predicting the amount of atmospheric suspended particulate matter by the atmospheric-suspended-particulate-matter-amount prediction unit 111 is not particularly limited, and various prediction methods may be used.

The atmospheric-suspended-particulate-matter-amount prediction unit 111 may collect weather information from, for example, a server (weather server) provided in a meteorological bureau or the like, and predict a current or future amount of atmospheric suspended particulate matter in the smart city based on the weather information. In addition, the atmospheric-suspended-particulate-matter-amount prediction unit 111 may predict a current or future amount of atmospheric suspended particulate matter in the smart city using a prediction model created in advance by machine learning based on data on a past amount of atmospheric suspended particulate matter. In addition, the atmospheric-suspended-particulate-matter-amount prediction unit 111 may predict a current or future amount of atmospheric suspended particulate matter in the smart city based on a detection value of a weather sensor or the like provided in the smart city. Note that, the atmospheric-suspended-particulate-matter-amount prediction unit 111 is only required to predict an amount of atmospheric suspended particulate matter at least at a place where the equipment group 20 is provided in the smart city.

The electric-power-amount calculation unit 112 calculates an electric power amount to be used to remove the atmospheric suspended particulate matter entering the equipment group 20 (hereinafter, referred to as a “removal electric power amount”) based on the amount of atmospheric suspended particulate matter predicted by the atmospheric-suspended-particulate-matter-amount prediction unit 111. The “removal electric power amount” includes electric power for moving a removal work vehicle that removes atmospheric suspended particulate matter accumulated on the equipment group 20, electric power to be supplied to a vehicle wash facility that washes a vehicle accumulated with atmospheric suspended particulate matter.

In addition, the electric-power-amount calculation unit 112 may predict an amount of the atmospheric suspended particulate matter entering the equipment group 20 to be naturally removed based on the weather before and after the atmospheric suspended particulate matter has fallen on the smart city to calculate the removal electric power amount in consideration of the predicted removal amount (natural removal amount) in addition to the amount of atmospheric suspended particulate matter predicted by the atmospheric-suspended-particulate-matter-amount prediction unit 111. The removal amount of the atmospheric suspended particulate matter entering the equipment group 20 is predictable based on, for example, information regarding the wind volume and the weather (for example, whether it rains or not) in the smart city included in the weather information. In this manner, by considering not only the amount of atmospheric suspended particulate matter in the smart city but also the amount of atmospheric suspended particulate matter to be naturally removed by wind or the like, it is possible to more accurately calculate the removal electric power amount. Accordingly, it is possible to optimize the electric power to be stored in the charging apparatuses 30 and to prevent excessive electric power from being stored in the charging apparatuses 30.

Note that, when the removal electric power amount is calculated in consideration of the removal amount of the atmospheric suspended particulate matter predicted based on the weather before and after the atmospheric suspended particulate matter has fallen on the smart city, the removal electric power amount increases or decreases depending on the weather. For example, when the weather before and after the atmospheric suspended particulate matter has fallen is rain, it is conceivable that the atmospheric suspended particulate matter attached to the equipment group 20 and vehicles sticks to them and is difficult to remove as compared with the case other than rain. Thus, the electric-power-amount calculation unit 112 calculates the removal electric power amount when the weather before and after the atmospheric suspended particulate matter has fallen is rain to be larger than the removal electric power amount when the weather is other than rain.

In addition, when the wind volume before and after the atmospheric suspended particulate matter has fallen is large, it is conceivable that the amount of the atmospheric suspended particulate matter attached to the equipment group 20 and vehicles to be naturally removed increases as compared with a small wind volume. Thus, the electric-power-amount calculation unit 112 calculates the removal electric power amount when the wind volume before and after the atmospheric suspended particulate matter has fallen is large to be smaller than the removal electric power amount when the wind volume is small.

In addition, the electric-power-amount calculation unit 112 may calculate the removal electric power amount in consideration of the number (scale) of pieces of equipment that malfunctions in the smart city. In this case, the electric-power-amount calculation unit 112 first acquires equipment information from the equipment group 20 and identifies, among the equipment group 20, which pieces of equipment malfunction due to falling of the atmospheric suspended particulate matter based on the equipment information. Note that, the “equipment information” indicates operating states of, for example, a sensor 21, a camera 22, and a charging stand 23 included in the equipment group 20, that is, information indicating whether or not each piece of the equipment is operating normally.

Then, the electric-power-amount calculation unit 112 calculates the removal electric power amount based on the number of pieces of the equipment that malfunction and the amount of atmospheric suspended particulate matter predicted by the atmospheric-suspended-particulate-matter-amount prediction unit 111. In this manner, by identifying, among the equipment group 20, which pieces of the equipment actually malfunction due to entering of the atmospheric suspended particulate matter, it is possible to more accurately calculate the removal electric power amount. Accordingly, it is possible to optimize the electric power to be stored in the charging apparatuses 30 and to prevent excessive electric power from being stored in the charging apparatuses 30.

After calculating the removal electric power amount, the electric-power-amount calculation unit 112 calculates a total electric power amount by adding the removal electric power amount to an electric power amount to be regularly supplied to the area. Note that, the “electric power amount to be regularly supplied to the area” indicates an electric power amount set based on a regular electric power demand from the equipment group 20, the facilities, or the like in the smart city and is separated from the removal electric power amount.

The charging control unit 113 performs charging control of the charging apparatuses 30 based on the electric power amount calculated by the electric-power-amount calculation unit 112. The charging control unit 113 performs charging control of storing, in the charging apparatuses 30, electric power equal to or more than the total electric power amount calculated by the electric-power-amount calculation unit 112. A specific method of the charging control by the charging control unit 113 is not particularly limited, and the charging control may be performed by, for example, determining a charging amount based on the total electric power amount calculated by the electric-power-amount calculation unit 112 at a predetermined cycle and on charging information (for example, a current charging capacity or the like) acquired in advance from the charging apparatuses 30 and transmitting, to each charging apparatus 30, a command to increase or decrease a current or future charging amount according to the charging amount.

The communication unit 12 is implemented by, for example, a local area network (LAN) interface board, a wireless communication circuit for wireless communication, or the like. The communication unit 12 is connected to the network NW such as the Internet, which is a public communication network. Then, the communication unit 12 communicates with the equipment group 20 and the charging apparatuses 30 by connecting to the network NW.

The storage unit 13 is implemented by recording media, such as an erasable programmable ROM (EPROM), a hard disk drive (HDD), a removable medium, and the like. Example of the removable media include disc recording media, such as a universal serial bus (USB) memory, a compact disc (CD), a digital versatile disc (DVD), and a Blu-ray (registered trademark) disc (BD). The storage unit 13 may store an operating system (OS), various programs, various tables, various databases, and the like. The storage unit 13 further stores, for example, the amount of atmospheric suspended particulate matter predicted by the atmospheric-suspended-particulate-matter-amount prediction unit 111, the removal electric power amount calculated by the electric-power-amount calculation unit 112, the charging amount of the charging apparatuses 30 determined by the charging control unit 113, and the like as necessary.

The equipment group 20 is a plurality of types of equipment provided at a predetermined place in the smart city and operates by electric power supplied from the charging apparatuses 30. The equipment group 20 includes a sensor (a human sensor, a weather sensor, or the like) 21 and a camera (a monitoring camera or the like) 22 used to collect information in the smart city, and a charging stand (a contact type charging stand, a non-contact type charging stand, or the like) 23 for battery electric vehicles and plug-in hybrid electric vehicles. In addition, the equipment group 20 may also include lighting, traffic signals, and the like provided in the smart city. In addition, the equipment group 20 transmits the equipment information indicating the operating state of the equipment group 20 to the charging control apparatus 10 sequentially or at a predetermined cycle.

The charging apparatuses 30 each store electric power to be supplied to the equipment group 20 and are provided inside the smart city or outside the smart city. The charging apparatuses 30 are each implemented by a general-purpose computer such as a workstation, a personal computer, and the like. In addition, the charging apparatuses 30 each include a battery for storing electric power, a control mechanism for controlling charging and discharging of electric power, and the like. In addition, the charging apparatuses 30 each transmit current charging information regarding each charging apparatus 30 to the charging control apparatus 10 sequentially or at a predetermined cycle.

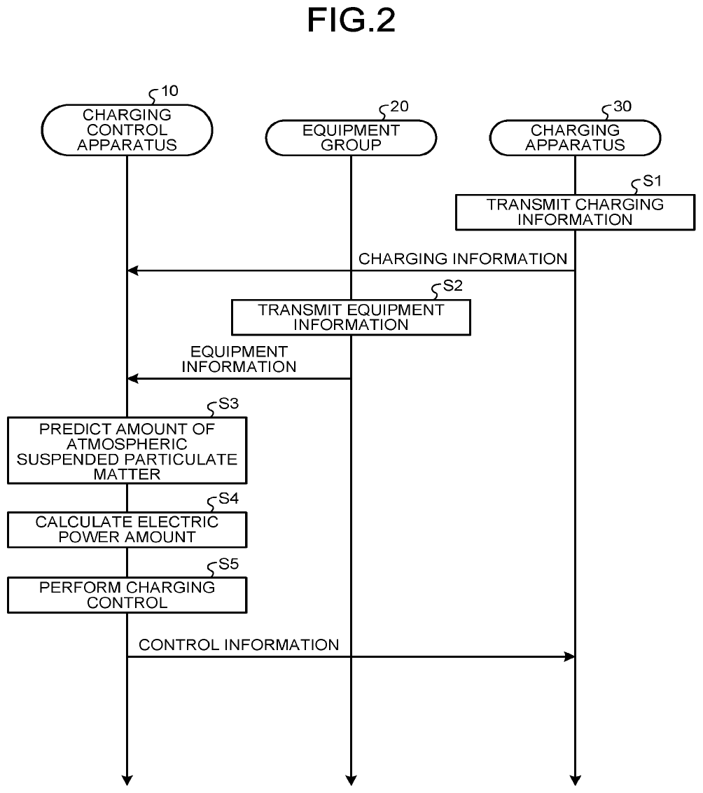

An example of a processing procedure of a charging control method performed by the charging control system 1 according to the embodiment will be described with reference to FIG. 2.

First, each charging apparatus 30 transmits charging information to the charging control apparatus 10 (step S1). Then, the equipment group 20 transmits equipment information to the charging control apparatus 10 (step S2). Note that, the order of steps S1 and S2 may be reversed.

Then, the atmospheric-suspended-particulate-matter-amount prediction unit 111 of the charging control apparatus 10 predicts an amount of atmospheric suspended particulate matter in the smart city based on weather information, a detection values of a weather sensor, or the like (step S3). Then, the electric-power-amount calculation unit 112 calculates a removal electric power amount based on the amount of atmospheric suspended particulate matter in the smart city and the equipment information, and then calculates a total electric power amount by adding the removal electric power amount to an electric power amount to be regularly supplied to the area (step S4). Then, the charging control unit 113 performs charging control of the charging apparatuses 30 based on the total electric power amount calculated in step S4 (step S5). With the above steps, the processing of the charging control method is completed.

As described above, with the charging control system, the charging control apparatus, and the charging control program according to the embodiment, it is possible to prevent electric power from running short when atmospheric suspended particulate matter falls on the smart city.

That is, when atmospheric suspended particulate matter floats in the smart city, the atmospheric suspended particulate matter may enter the equipment group 20 provided in the smart city, and whereby the equipment group 20 may malfunction. For this reason, it is necessary to remove the atmospheric suspended particulate matter using a removal work vehicle and a car wash facility. However, if, for example, electric power required by general households and various facilities increases at the same time, the electric power consumption peaks, and electric power for operating the removal work vehicle and the car wash facility may run short.

In contrast, the charging control system, the charging control apparatus, and the charging control program according to the embodiment calculate a removal electric power amount based on the predicted amount of atmospheric suspended particulate matter and perform charging control of the charging apparatuses 30 based on the removal electric power amount, and electric power does not run short when atmospheric suspended particulate matter falls. In addition, with the charging control system, the charging control apparatus, and the charging control program according to the embodiment, it is possible to secure electric power for removing the atmospheric suspended particulate matter entering the equipment group 20 and to prevent the equipment group 20 from malfunctioning.

Furthermore, with the charging control system, the charging control apparatus, and the charging control program according to the embodiment, the charging control is performed in such a manner that electric power more than consumption is not stored in the charging apparatuses 30, and it is possible to prevent wasteful electric power and deterioration of the battery.

According to the present disclosure, it is possible to prevent electric power from running short when atmospheric suspended particulate matter falls on a smart city.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charging control system comprising:
a charging apparatus comprising a first processor, the charging apparatus being configured to store electric power to be supplied to a preset area;
an equipment group provided in the preset area and comprising a second processor, the equipment group being configured to be supplied with the electric power from the charging apparatus; and
a charging control apparatus comprising a third processor, the third processor being configured to:
predict an amount of atmospheric suspended particulate matter floating in the preset area;
calculate, based on the predicted amount of the atmospheric suspended particulate matter, a removal electric power amount to be used to remove the atmospheric suspended particulate matter entering the equipment group;
calculate a total electric power amount by adding the removal electric power amount to an electric power amount to be regularly supplied to the preset area; and
perform charging control of storing electric power equal to or more than the total electric power amount in the charging apparatus.

2. The charging control system according to claim 1, wherein the third processor is configured to:
predict, based on weather before and after the atmospheric suspended particulate matter has fallen on the preset area, an amount of the atmospheric suspended particulate matter entering the equipment group to be naturally removed; and
calculate the removal electric power amount in consideration of the predicted removal amount.

3. The charging control system according to claim 1, wherein
the second processor is configured to output, to the charging control apparatus, equipment information indicating an operating state of the equipment group, and
the third processor is configured to:
identify, among the equipment group, which one or more pieces of equipment malfunction due to falling of the atmospheric suspended particulate matter based on the equipment information; and
calculate the removal electric power amount in consideration of the number of the one or more pieces of equipment that malfunction.

4. A charging control apparatus comprising
a processor configured to:
predict an amount of atmospheric suspended particulate matter floating in a preset area;
calculate, based on the predicted amount of the atmospheric suspended particulate matter, a removal electric power amount to be used to remove the atmospheric suspended particulate matter entering an equipment group provided in the preset area;
calculate a total electric power amount by adding the removal electric power amount to an electric power amount to be regularly supplied to the preset area; and
perform charging control of storing electric power equal to or more than the total electric power amount in a charging apparatus configured to supply electric power to the preset area.

5. The charging control apparatus according to claim 4, wherein the processor is configured to:
predict, based on weather before and after the atmospheric suspended particulate matter has fallen on the preset area, an amount of the atmospheric suspended particulate matter entering the equipment group to be naturally removed; and
calculate the removal electric power amount in consideration of the predicted removal amount.

6. The charging control apparatus according to claim 4, wherein the processor is configured to:
acquire equipment information indicating an operating state of the equipment group from the equipment group;
identify, among the equipment group, which one or more pieces of equipment malfunction due to falling of the atmospheric suspended particulate matter based on the equipment information; and
calculate the removal electric power amount in consideration of the number of the one or more pieces of equipment that malfunction.

7. A non-transitory computer-readable recording medium on which an executable program is recorded, the program causing a processor of a computer to execute:
predicting an amount of atmospheric suspended particulate matter floating in a preset area;
calculating, based on the predicted amount of the atmospheric suspended particulate matter, a removal electric power amount to be used to remove the atmospheric suspended particulate matter entering an equipment group provided in the preset area;
calculating a total electric power amount by adding the removal electric power amount to an electric power amount to be regularly supplied to the preset area; and
performing charging control of storing electric power equal to or more than the total electric power amount in a charging apparatus configured to supply electric power to the preset area.

8. The non-transitory computer-readable recording medium according to claim 7, wherein the program causes the processor to execute:
predicting, based on weather before and after the atmospheric suspended particulate matter has fallen on the preset area, an amount of the atmospheric suspended particulate matter entering the equipment group to be naturally removed; and
calculating the removal electric power amount in consideration of the predicted removal amount.

9. The non-transitory computer-readable recording medium according to claim 7, wherein the program causes the processor to execute:
acquiring equipment information indicating an operating state of the equipment group from the equipment group;
identifying, among the equipment group, which one or more pieces of equipment malfunction due to falling of the atmospheric suspended particulate matter based on the equipment information; and
calculating the removal electric power amount in consideration of the number of the one or more pieces of equipment that malfunction.
